(19) United States
(12) Patent Application Publication
(10) Pub. No.: US 2005/0249458 A1
(43) Pub. Date: Nov. 10, 2005

(54) Wavelength selection device

(75) Inventor: Seimi Sasaki, Sagamihara (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/078,522

(22) Filed: Mar. 14, 2005

(30) Foreign Application Priority Data
May 6, 2004 (JP) 2004-137772

(51) Int. Cl. G02B 6/28

(52) U.S. Cl. 385/24

(57) ABSTRACT

An optical module is adapted for use in wavelength multiplex optical communication, and the optical system of a wavelength selection control device can control (switching and attenuation or the like) the multiplexed signal independently for each channel in a different wavelength.

### BACKGROUND OF THE INVENTION

1. Field of the Invention

The present invention relates to an optical module to be adapted for use in wavelength multiplex optical communication, and particularly to the structure (optical system) of a wavelength selection control device that can control (switching and attenuation or the like) the multiplexed signal independently for each channel in different wavelength.

The realization of large capacity in the transmission path is an essential problem, due to the speed of expansion of the Internet and mobile telephone systems as well as the diversification of terminal devices.

Since the communication network depends on optical fiber that can transmit data at high speed and in large capacity, the establishment of an optical communication network based on the wavelength division multiplex (WDM) system is just the merely the first in a series of problems to be solved.

However, there are several difficulties associated with the establishment of this WDM communication system. One of the most significant of these problems is the realization of an optical switch suitable for the WDM system.

In a WDM communication system, the technology for realizing the high speed operation of a communication node, or transmitting apparatus, has lagged behind in the achievement of large capacity of the transmission path. Thus, it is now recognized that the communication node is likely to become a bottleneck of the network.

High speed operation of the communication node is primarily restricted by electronic signal processing within the electronics circuits. One method for obtaining higher speeds is to include in each WDM channel within the all-optical network a switching node that can switch the optical signals to different ports without the currently required, slower step of conversion of the optical signals into electronic signals.

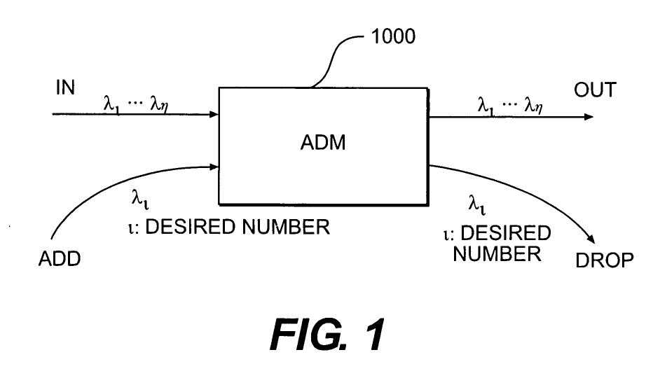

A typical structure of an all-optical switch used in the WDM communication is illustrated in FIG. 1. This all-optical switch is also called an optical Add-Drop Multiplexing (ADM) apparatus 1000. The optical ADM apparatus is provided with an add-port and a drop-port. The add-port allows for the inputting of signals to be added to the transmission path of the trunk line connecting communication nodes, and the drop-port allows for outputting extracted signals. At present, the only structure put into practical use is the combined wavelength multiplexer/demultiplexer (MUX1002/DEMUX1001) and 2×2 switch 1003-1 to 1003-n. It is thus not clear whether such a structure is an effective and economical optical switch for the WDM communication system. It may be possible to significantly lower the cost of an optical network by replacing the aforementioned structure.

Moreover, further difficulties may be introduced by the optical attenuator currently suitable for WDM systems. In a long-distance communication system it is essential to provide an optical amplifier to compensate for signal loss in the optical fiber. However, there exists a dependence on the wavelength of gain (the “gain tilt”) present in optical amplifiers, and this gain tilt restricts transmission distance in the WDM system.

Accordingly, in order to reduce such dependence on the wavelength of the gain, a method is needed for demultiplexing (branching) the wavelength multiplex signals, and again multiplexing the wavelengths after giving adequate attenuation to each optical signal of each channel.

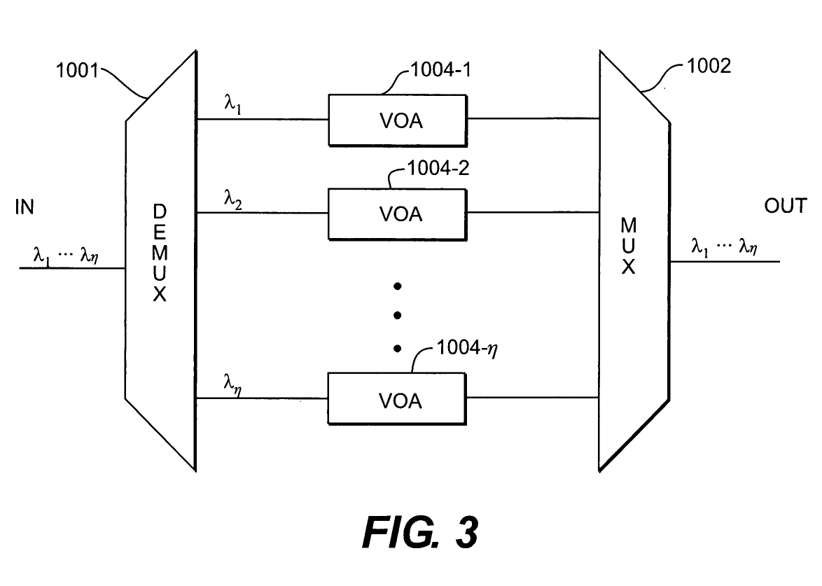

A structure to realize this method is illustrated in FIG. 3.

The wavelength multiplex signal is at first demultiplexed (branched) by the wavelength multiplexer/demultiplexer MUX1002. Then each optical signal of each channel is adequately attenuated with a plurality of optical attenuators (VOA) 1004-1 to 1004-n. Thereafter, the demultiplexed signals are again multiplexed with the wavelength multiplexer/demultiplexer DEMUX1001.

In this structure, as many optical attenuators (VOA) are required as there are channels of WDM, resulting in devices that are large, complicated, and expensive.

To remedy the aforementioned issues, the wavelength selection control device must be designed to realize a reduction in size and an increase in economy. This can be accomplished by integrating the wavelength multiplexing/demultiplexing functions and control (switching, attenuation) functions.

Moreover, it is also very important to realize further reduction in cost by attaining different functions such as switching and attenuation with a common optical system and component structure.

The present invention has been proposes a structure (optical system) of a wavelength selection control device in order to fulfill such requirements.

2. Description of the Related Art

Detailed below are examples of existing technology that attempts to realize an integrated wavelength selection control device.

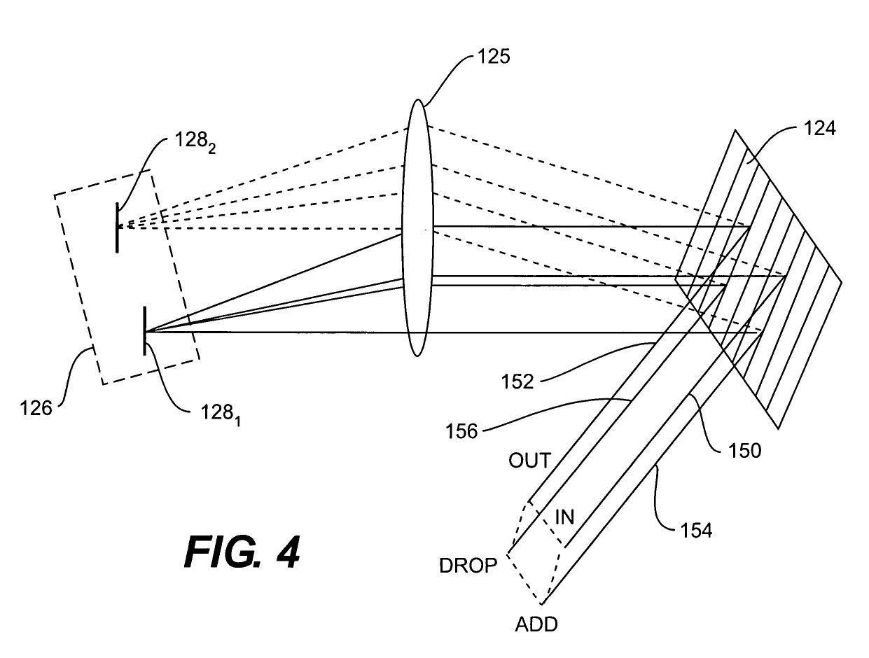

FIG. 4 illustrates a structure of an optical ADM, as disclosed in the U.S. Pat. No. 5,960,133 (Patent Document 1, henceforth, referred to as prior art 1).

An optical system 126 is formed from a basic structure of a spectral element (diffraction grating) 124, a lens 125, and a movable micro-mirror 128. In this case, the spectral element 124 and movable micro-mirror 128 are positioned in the confocal arrangement positions of the lens 125. Input and output of the light to and from this optical system occurs through a two-dimensional array of four ports. The respective ports function as an input (IN) port, an output (OUT) port, an add port, and a drop port.

The beams 150, 152, 154, and 156 of respective ports are inputted and outputted in parallel toward the spectral element 124. The wavelength multiplex beam 150 from the input port enters the spectral element 124 and is space-isolated at different angles for each wavelength.

Each beam of the space-isolated wavelength is condensed, through the lens 125, onto different micro-mirrors 128₁ and 128₂.

Here, the reflected beam can be freely extracted from the output port or the drop port by changing the direction of individual micro-mirrors 128₁ and 128₂.

Similarly, the incident beam from the add port can also be extracted freely from the output port or the drop port.

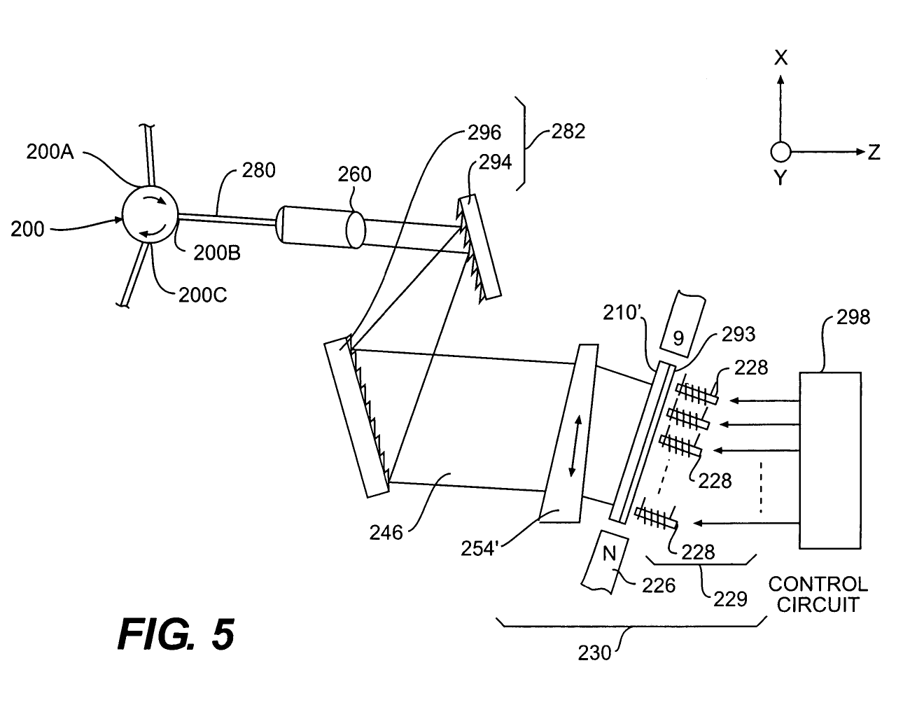

FIG. 5 illustrates the structure of an optical attenuator disclosed by Japanese Unexamined Patent Publication No. 1999-119178 (Patent Document 2, henceforth, referred to as prior art 2).

This optical device is comprises a spectral element 282, a double refraction crystal 254, a magneto-optical crystal 210, and a means 229 for creating a magnetic field distribution within magneto-optical crystal 210.

A fiber 280 carries the light from a port 200B which outputs the light inputted to a port 200A of an optical circulator 200.

The light inputted via a port 200A to an optical circulator 200 is outputted through port 200B to fiber 280.

The wavelength multiplex signal beam outputted from fiber 280 is subjected to the angular dispersion (spectroscopic analysis), space-isolated for each wavelength (channel), and is inputted to a magneto-optical crystal 210 through a wedge type double refraction crystal 254.

The magneto-optical crystal 210 is given the desired magnetic field distribution by an electro-magnet 228 and a magnet 226 which are controlled by a control circuit 298.

The angular dispersion light is then subjected to Faraday rotation in accordance with respective magnetic field strengths within the magneto-optical crystal 210 and is returned by a reflection film 293.

In this case, the Faraday rotation is performed within the double refraction crystal 254 such that the light is attenuated in accordance, with the magnetic field strength; therefore, desired attenuation can be attained for each channel.

2. Description of the Prior Art

A wavelength selection control device is requested to realize reduction in size and increase in economy through the integration of its components.

However, the prior arts listed above still include following difficulties that impede realization of the object described above. In the prior art 1, the micro-mirror 128 is used as a light returning means. A micro-mirror is described in detail, for example, in the U.S. Pat. No. 5,579,151 (Patent Document 3). As is apparent from the Patent Document 3, the tilt (tilt-angle) of the micro-mirror is not changed continuously but is limited to particular discrete angles, for example, −10°, 0°, and +10°, allowing at most the existence of only three stable states (tilt angles).

Therefore, a lens 160 is required to return each beam that was space isolated by the spectral element to a point on the spectral element via reflection by the micro-mirror.

Specifically, a spectral element 161 and a micro-mirror (light returning component) 162 are arranged to bring about the result of d1=d2=f for the lens 160 of focal length f.

Accordingly, each collimate beam 163 space-isolated by the spectral element 161 is converted to the parallel beam arrays 164 by lens 160. These beams enter in the identical input light angle to each micro-mirror (light returning component) 165:

The micro-mirror 165 reflects' for each beam at the same angle. Therefore, each beam is returned in parallel to a point on the spectral element 161 transmitting through the lens 160.

In this optical system, each angular dispersion beam (collimate beam) 164 is recued in diameter by the lens 160 when it enters the micro-mirror 165.

Therefore, the light beam is returned in the collimate diameter identical to that of the incident light by arranging the reflection surface of the micro-mirror 165 to result in d2=f and reflecting each beam at the beam waist position.

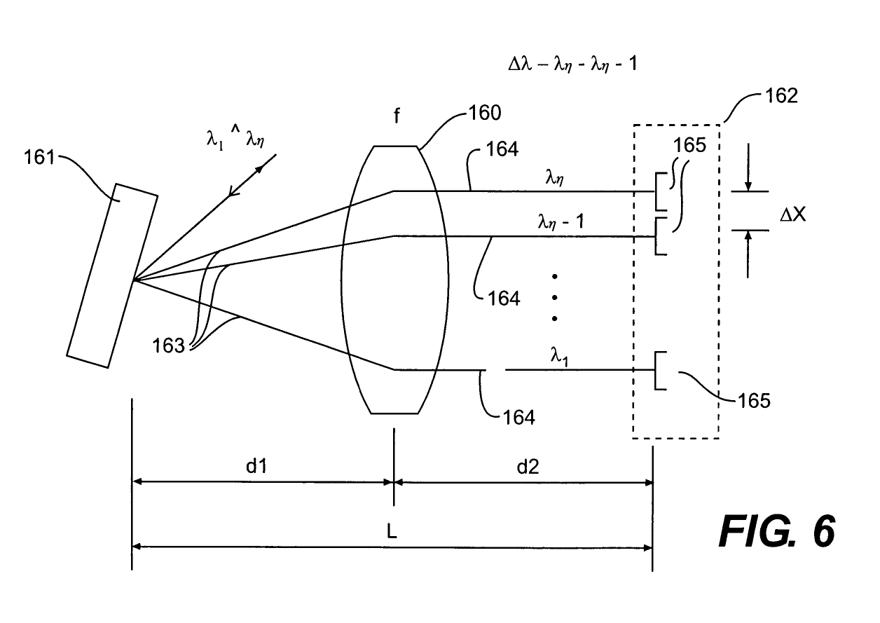

Meanwhile, requirements for wavelength pitch among channels becomes narrower in order to increase the transmission capacity in the WDM system. At present, it is required to realize an interval of 0.8 nm (100 GHz) or narrower. In this case, when the optical systems illustrated in FIG. 4 and FIG. 6 are employed, the optical path length L can be derived from the following conditions.
Wavelength λ: 1550 nm
Wavelength interval of adjacent channels Δλ:
   0.8 nm
Interval of adjacent micro-mirrors ΔX:
   0.5 mm
Number of grooves of diffraction grating N:
   600/mm
Input light angle of wavelength multiplex beam φ:
   43°
Diffraction angle θ (m=1): 14.4°
   (m: Number of diffraction orders)
      (Light path length)
Focal length of lens f: 101 cm
Optical path length L (=2f): 202 cm

Namely, a total optical path length of about 2 m is required to isolate the signal in the wavelength interval of 0.8 nm in the space interval of 0.5 mm.

In the WDM system in which the wavelength interval is as close as described above, it has been difficult to manufacture, in a smaller size, the corresponding wavelength selection control device.

If a reduction in size is folding the optical path in multiple corners using a plurality of mirrors or the like, the structure suffers several difficulties imposed by the increased complexity. For example proper assembly becomes problematic due to an increased number of components, and these same components take part in the generation of excessive loss within the system.

In prior art 2 of FIG. 5, the spectrally analyzed light beam is converted to the parallel light beam through combination of the diffraction gratings 296 and 294. Since the spectrally analyzed beam is propagated as it is maintained as the collimate beam (not recued in diameter by lens as illustrated in FIG. 6) in this optical system, the distance corresponding to d2 of FIG. 6 is basically not required for operation of the system. Therefore, it is possible to reduce L to nearly half the value shown in FIG. 6.

Though the length may be shorter in this system, refraction efficiency of the diffraction grating is generally about 75%, and, in terms of insertion loss, is about 1.25 dB. This is especially problematic when compared to the insertion loss of the lens (about 0.3 dB).

Namely, prior art 2 has been accompanied by the characteristic problem that the insertion loss of the optical system is about two times the loss in FIG. 5 because two sheets of diffraction gratings (two times in the optical system of FIG. 6) are employed. The diffraction gratings also increase the difficulty of limiting the insertion loss from the dependence on polarization (PDL) to a small value.

### SUMMARY OF THE INVENTION

In light of the difficulties present in the prior art, the present invention is designed to enable a reduction in size and an increase in economy in the design and construction of an optical wavelength selection device.

As a first means for solving the problems, a wavelength selection device comprises:
a spectral element for the angular dispersion of the wavelength multiplexed light beam at different angles for each wavelength;
an optical element for expanding the spread angle of the angular dispersion beam; and
a first lens for converting the angular dispersion light beam into the parallel light beam and forming spot arrays space-isolated for each wavelength.

As the second means for solving the problems, the wavelength selection device utilizing the first means further comprises an optical element that arranges the second and third lenses in a system with focal lengths based on the confocal arrangement.

As the third means for solving the problems, the wavelength selection device further comprises a spectral element designed as a reflection type element, wherein the wavelength multiplex signal is reciprocally transmitted through the optical element before and after the wavelength multiplex signal enters the spectral element. The Littrow mounting is employed for this element such that the input light angle for the spectral element is almost identical to the spread angle of the angularly dispersed light near the center wavelength in the wavelength band of the wavelength multiplex signal.

As the fourth means for solving the problems, the wavelength selection device utilizing the first means further comprises a light returning component for returning the angularly dispersed light to the spectral element, wherein a reflection point is allocated at the beam spot (focal point) generated by the first lens.

As the fifth means for solving the problems, the wavelength selection device utilizing the fourth means comprises, as an element of the light returning component, a first reflection device for returning the angularly dispersed light in a direction accurately opposed to the incident light, and a second reflection device for returning the light in a direction that is different from that provided by the first reflection device.

Following these guidelines, the present invention allows for the realization of a small size spread optical system. This is accomplished through integration of components, common use thereof, and simpler assembly of the wavelength selection control device, resulting in significant reduction in size and cost, as well as enabling mass production of such optical device.

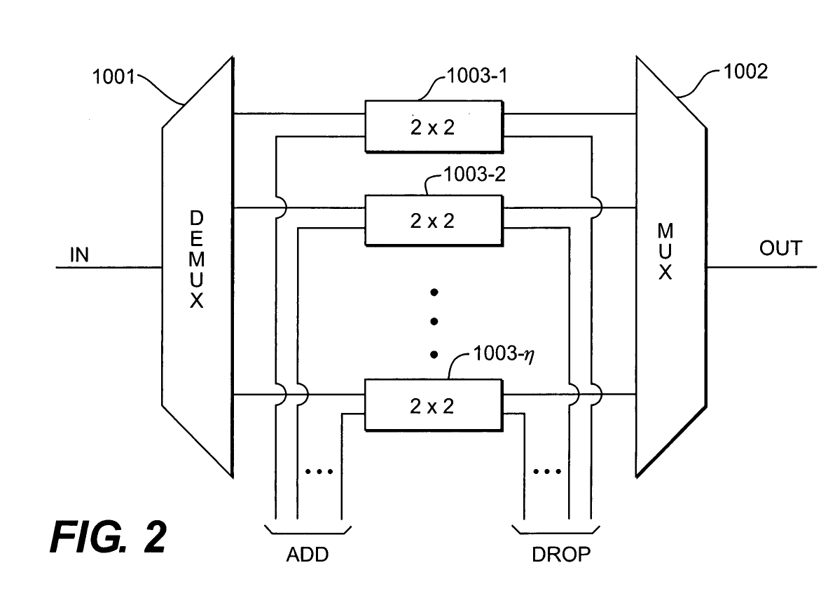

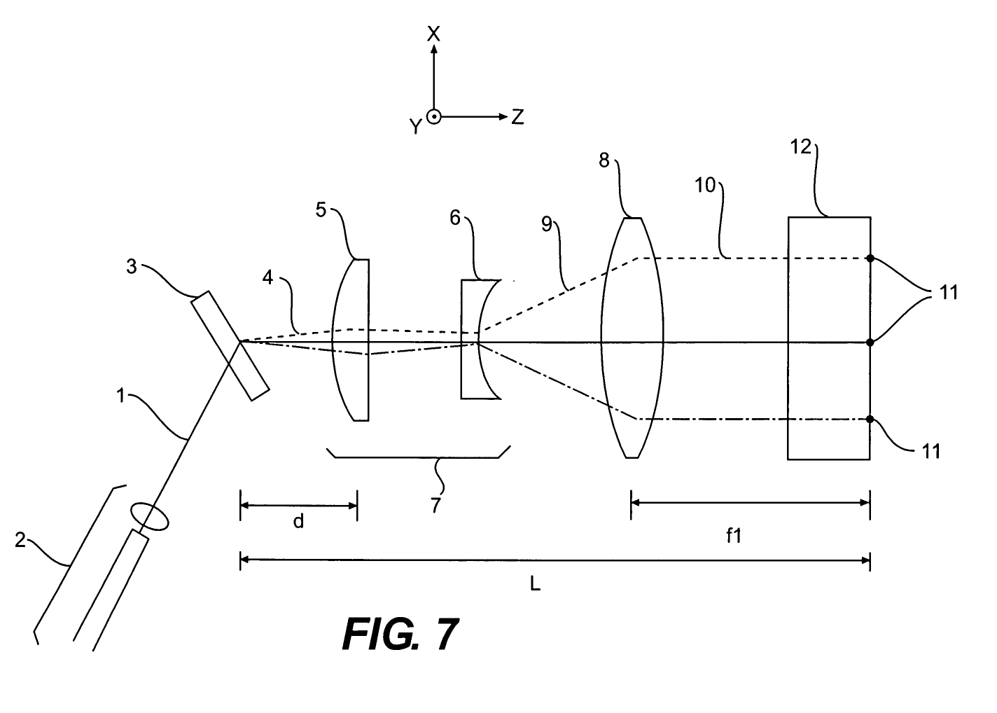

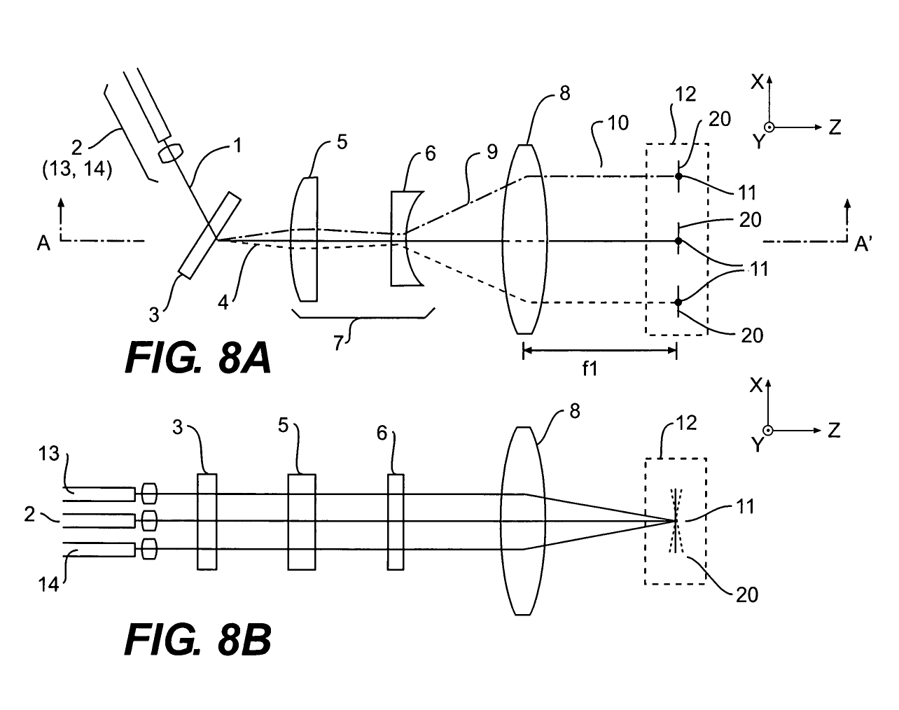

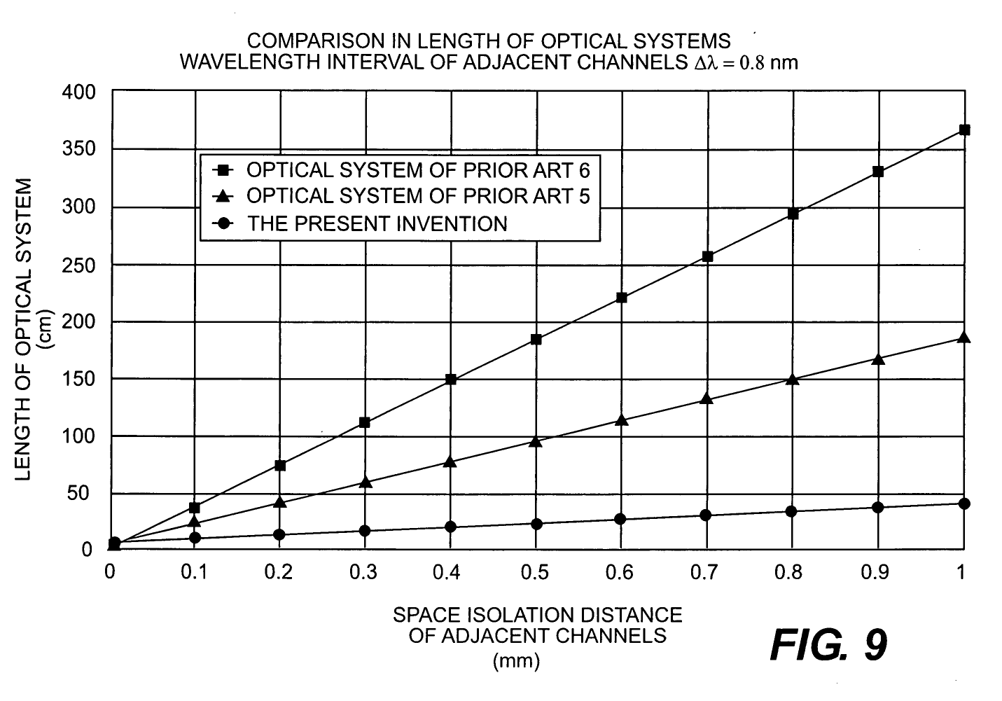

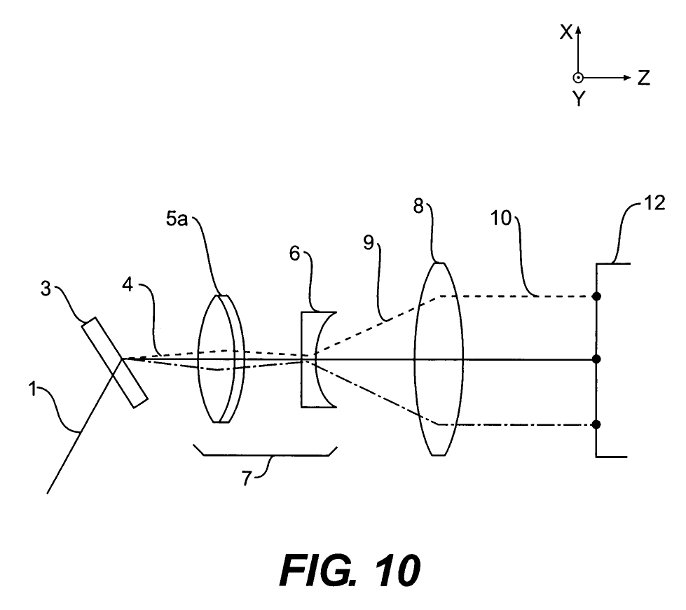

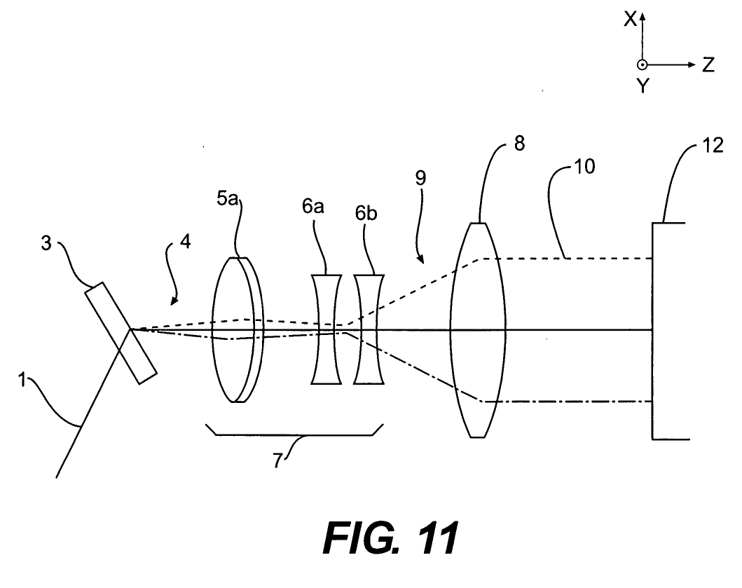

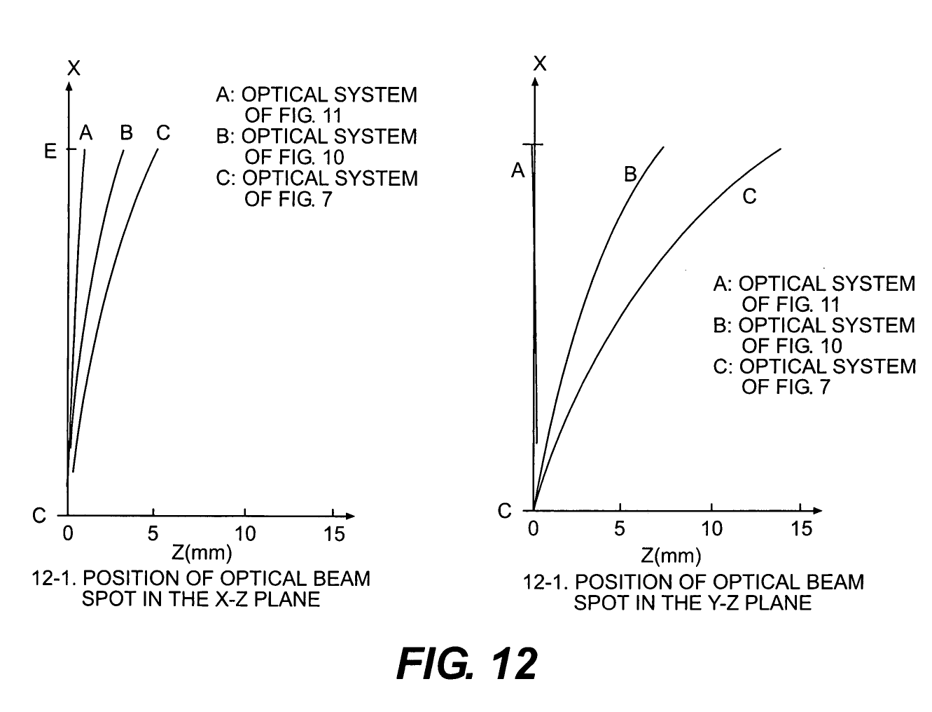

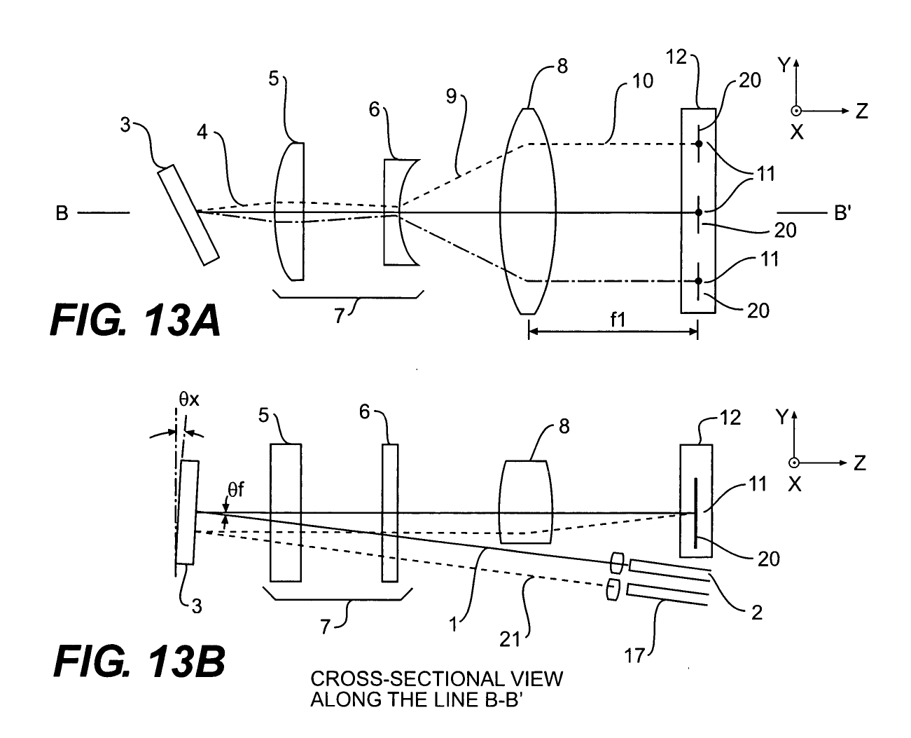

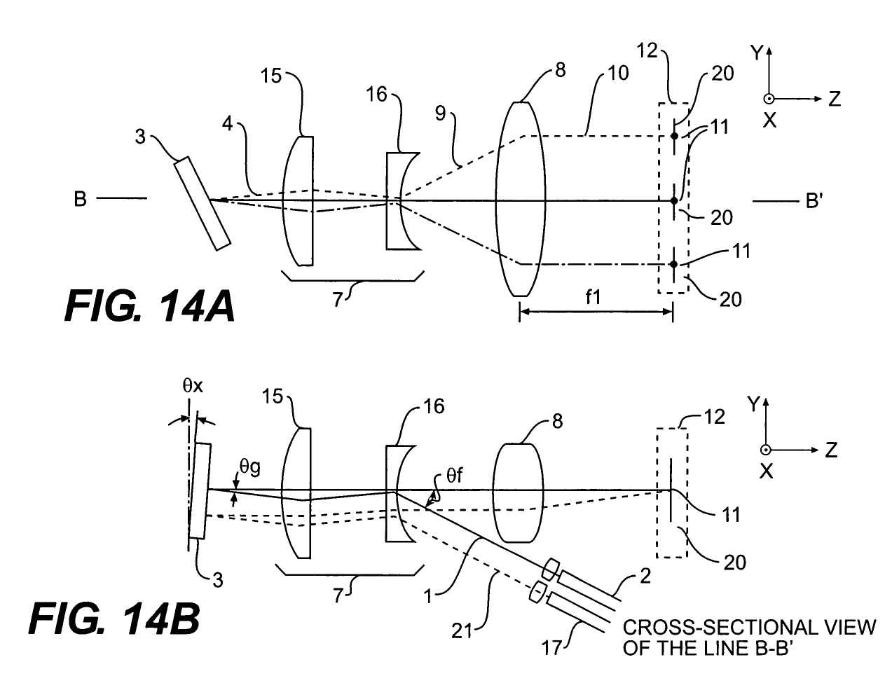

### BRIEF DESCRIPTION OF THE DRAWINGS

[FIG. 1] Diagram for describing an all-optical switch.

[FIG. 2] Diagram for describing the all-optical switch of the prior arts.

[FIG. 3] Diagram for describing an optical attenuation structure of the WDM system of the prior arts.

[FIG. 4] Diagram illustrating the prior art 1.

[FIG. 5] Diagram illustrating the prior art 2.

[FIG. 6] Diagram illustrating the optical system of the prior art 1.

[FIG. 7] Diagram for describing the optical system of the present invention.

[FIGS. 8A and 8B] Diagrams for describing the optical system of the present invention.

[FIG. 9] Diagram for comparing lengths of the optical system.

[FIG. 10] Diagram for describing the optical system of the present invention.

[FIG. 11] Diagram for describing the optical system of the present invention.

[FIGS. 12A and 12B] Diagrams illustrating comparison of astigmatism.

[FIGS. 13A and 13B] Diagrams for describing the optical system of the present invention.

[FIGS. 14A and 14B] Diagrams for describing the optical system of the present invention.

### DESCRIPTION OF THE REFERENCE NUMERALS

3 . . . Spectral element;
4 . . . Beam;
5 . . . Second lens;
6 . . . Third lens;
7 . . . Optical system element;
8 . . . First lens;
12 . . . Light returning component;

### DESCRIPTION OF THE PREFERRED EMBODIMENTS

FIG. 7, FIGS. 8A and 8B, FIGS. 9 and 10, FIG. 11, FIGS. 12A and 12B, FIGS. 13A and 13B, and FIGS. 14A and 14B explain the principle of the preferred embodiment of the present invention.

FIG. 7 and FIGS. 8A and 8B illustrate an optical system of a wavelength selection control device. The beam including the wavelength multiplex signal (collimate beam) 1 is incident to a spectral element 3 from an incident port 2.

Here, a spectral element 3 is, for example, a diffraction grating or a prism.

The spectral element 3 divides the wavelength multiplex signal 1 into a plurality of wavelength multiplexed beams 4 (indicated with a solid line, a broken line, and a chain line in FIG. 7).

Here, the beams 4 are space spread (angular dispersion) in the X direction illustrated.

The beams 4 analyzed by the spectral element 3 are inputted to an optical system element 7 formed of a second lens 5 and a third lens 6.

The second and third lenses are arranged in the manner wherein an interval of these lenses becomes equal to a sum of the focal lengths thereof (confocal system) to form the optical system element 7 for so-called beam expanding.

The second and third lenses 5, 6 are formed of the lenses having the curved surface at least in the X direction and the focal lengths thereof indicate the values in the Z direction.

The optical system 7 for beam expanding enables expansion and compression of beam diameter and that of the input light angle (formed by the light beam and optical axis) in accordance with a ratio of the focal lengths of the second and third lenses 5, 6 (respectively defined as f2, f3).

That is, the beam 4 inputted from the side of the second lens 5 is scaled to f3/f2 times the beam diameter when it is outputted from the third lens 6 and the output angle thereof (formed by the light beam and optical axis) is scaled to f2/f3 times.

In the optical system of FIG. 7, the lenses are selected such that f2>f3.

The beam 4 in each wavelength spread by the spectral element 3 passes through the optical element 7 for beam expanding and is thereafter reduced in the beam diameter by f3/f2 times. As a result, the spread angle of angular dispersion is expanded by a factor of f2/f3.

Moreover, the first lens 8 (focal length: f1) is arranged to convert the spread beam 9 of each wavelength into a parallel light beam.

With the structure described above, after having passed the first lens 8, the beam of each wavelength forms a single-dimensional spot array 11 in the X direction, which is space-spread for each wavelength at the distance of f1, the focal length of the first lens.

In addition, it is possible to design the structure such that the space-spread beam spot 11 of each wavelength is returned to the spectral element 3 by the light returning component 12 as illustrated in FIG. 7 and FIGS. 8A and 8B. In this case, the light returning component 12 is arranged to provide a reflection point at the beam waist (focal point) position generated by the first lens 8.

1. Detailed Description of FIG. 7

The spectral element 3 selects a transmitting type diffraction grating and uses, for example, a quartz glass substrate. The grating is formed by an etching process or the like. The second and third lenses, 5 and 6, form the optical system element 7 for beam expansion, expanding and compressing the beam diameter in the spread direction (X direction) of the spectral element 3.

For example, lens 5 may be a cylindrical lens with a focal length f=62 mm, while the third lens 6, may be a cylindrical lens with focal length f=−6.56 mm. Here, a positive value of focal length indicates a convex lens, while a negative value thereof indicates a concave lens. These lenses may be formed of any material that is transparent to the wavelength multiplex signal light. For example quartz glass may be used.

The second and third lenses are arranged such that an interval thereof (between the second principal point of the second lens and the first principal point of the third lens) becomes equal to a sum of the focal lengths of lenses (confocal system).

Moreover, direction of lens curvature is determined to expand or compress the beam diameter in the spread direction (the lens has the surface curved in the X direction).

In the case of this embodiment, the lenses are arranged such that a distance between the principal points of lenses (distance between the second principal point of the second lens and the first principal point of the third lens) becomes equal to 55.44 mm.

Accordingly, the expansion and compression ratio of the beam diameter becomes about 9.5 (=62/6.56).

Given the prior listed attributes for the lenses, the first lens 8 is chosen to be a convex lens with a focal length f=41.3 mm, and positioned to convert the spread beam (having passed the beam expanding optical system element) into the parallel beam. It is preferable that the first lens 8 be positioned through adjustment by monitoring the conversion of the spread beam to the parallel beam.

In this optical system, the wavelength multiplex signal light propagated through an optical fiber 2 is converted to the collimate beam with the lens 2 and then enters the spectral element 3.

Here, the range of wavelengths included in the wavelength multiplex signal light is, for example, 1525 nm to 1565 nm (center wavelength: 1545 mm), and a channel interval is 0.8 nm.

The diameter of the collimate beam is previously expanded only in the angular dispersion direction to form a light beam with an elliptical cross-section, with the diameter compressed in the angular dispersion direction by the optical system element 7 for beam expanding.

Namely, the diameter in the angular dispersion direction (X direction) is set to 3.42 mm, while the diameter in the vertical direction to X direction (Y direction) is set to 0.36 mm.

Accordingly, the diameter of collimate beam 9 after having passed the optical system element 7 for beam expanding is reduced to 0.36 mm because the diameter in the X direction is reduced to (1/magnification factor) of the optical system element 7 for beam expanding. That is, the light beam becomes the circular beam having the diameter of 0.36 mm both in the X and Y directions.

The diffraction grating 3 has 667 grooves/mm and the input light angle to the diffraction grating is set to 30 degrees.

In this embodiment, the wavelength multiplex signal light 1 inputted to the diffraction grating is spread with a center diffraction angle of 32° and spread angle width of 1.8 (the diffraction angle of each wavelength is 31.1° for 1525 nm, 32° for 1545 nm, and 32.9° for 1565 nm).

The angular dispersion beam 4 is expanded in the spread angle width after having passed through the optical system element 7 for beam expanding.

The expansion rate is determined by the focal point ratio of the second and third lenses 5 and 6 forming the optical system element 7 for beam expanding. In the case of this embodiment, the expansion ratio is about 9.5 (=62/6.56).

Accordingly, the spread beam 9 is propagated, after having passed the optical system element 7 for beam expanding, with an expanded spread angle width of 17°. Moreover, the beam diameter is compressed to 1/9.5 (an inverse number of the expansion rate) only in the angular direction and the light beam becomes the circular beam with a diameter of 0.36 mm.

Thereafter, the first lens 8 converts the spread beam 9 into the parallel beam 10, and each collimate beam is reduced in diameter at the focal point to form the beam spot 11 for each wavelength, which is reduced to about 100 μm with the first lens 8 (f=41.3 mm). Moreover, a beam interval ΔX of each channel becomes about 250 μm.

Thus it is possible to form a one dimensional spot array in which the wavelength multiplex light is space-isolated for each channel.

FIG. 7 illustrates a structure to return these space-isolated beam spots 11 to the spectral element 3 via the light returning component 12.

As in the case of the prior art 2, the light returning component 12 is formed of a double refraction crystal, a magneto-optical crystal and a means for generating the desired magnetic field distribution within these elements. (Details are not illustrated. Refer to 230 in FIG. 5.)

The rear surface of the magneto-optical crystal is coated with a reflection film and positioned such that the reflection film is located at the beam spot (waist) position 11.

Moreover, the direction of the magneto-optical crystal (reflection film) is set to return the beam spot in the direction accurately opposed to that of the incident light, i.e. from light returning component 12 to spectral element 3.

In this structure, the space-isolated beam 10 is inputted to the magneto-optical crystal (12).

The magneto-optical crystal is given a desired magnetic field distribution and each beam is subjected to a Faraday rotation in accordance with the magnetic field intensity within the magneto-optical crystal.

The double refraction crystal is designed to attenuate the light beam in accordance with the angle of Faraday rotation (magnetic field intensity). After the desired attenuation in each channel, the light beam is returned to the optical fiber.

As illustrated in FIGS. 8A and 8B, the light returning component may also comprise a first reflection means for returning the light beam in the direction accurately opposed to that of the incident light, i.e. from light returning component 12 to the spectral element 3. This component may further comprise a second means that differs from the first reflection means at least in the direction in which light is returned. It is preferable that the second reflection means return the light in an orientation perpendicular (Y-Z plane) to the spread direction (X direction) of the spectral element 3.

The direction in which each wavelength of the beam is returned may be altered through the switching operation of the first reflection means and the second reflection means.

If the beam is returned accurately in the opposing direction by the first means, it is then returned accurately to the incident port 2.

If the beam is returned via the second means in a direction different from the incident direction of the light, it is then returned to the other ports 13, 14.

Here, the optical system element for beam expanding formed of the second the third lenses 5, 6 may be of a so-called Galilei-type formed by a combination of a lens having a positive focal length and a lens having a negative focal length.

The first and second reflection means are respectively formed of a movable type micro-mirror 20 and a plurality of movable micro-mirrors 20 that can take the conditions of the first reflection means and the second reflection means in accordance with requirement of the movable condition thereof.

2. Detailed Description of FIGS. 8A and 8B

In FIGS. 8A and 8B, FIG. 8B is a cross-sectional view along the cutting line A-A in FIG. 8A.

In comparison with FIG. 7, the optical fiber and light returning component are different (other optical systems are identical).

The optical fibers 2, 13, 14 are formed of an array of three ports. Port 2 functions as an input/output (IN/OUT) port, port 13 an add (ADD) port, and port 14 a drop (DROP) port.

The light returning component 12 is formed of the movable micro-mirror 20 and this component is positioned such that the reflection surface of the micro-mirror 20 is located at the beam spot (focal point) position 11 generated with the first lens 8.

Moreover, stable direction of the micro-mirror in a certain tilt angle is set to return the beam spot in the direction accurately opposed to the propagation direction of the incident light, i.e. from to the micro-mirror 20 from the spectral element 3.

In this structure, the wavelength multiplex signal light 1 is inputted from the input (IN) port 2, each channel is space-isolated with the interval of about 250 μm through processes similar to those in the first embodiment. Thereby, the single-dimensional (X direction) spot array 11 in the diameter of about 100 μm can be obtained.

The movable micro-mirror 20 as the light returning component 12 has three stable states: −10°, 0°, +10°.

Moreover, the micro-mirror 20 is arranged in a pitch identical to that (about 250 μm) of the beam spot array 11 to independently control the returning direction of the beam 10 for each channel.

Here, the moving direction of the micro-mirror 20 and the direction of arrangement of the optical fibers (three ports) 2, 13, 14 are set in the vertical direction (Y direction) to the angular dispersion direction (X direction).

When the tilt of micro-mirror 20 is 0°, the beam inputted from the input/output port 2 returned again to the input/output port 2.

When the tilt is set at −10°, the beam inputted from the input/output port 2 is subjected to a change in the optical path at the micro-mirror 20 and is then outputted to the drop port 14 after traveling parallel to the main optical path (i.e. input optical path from the input/output port 2) after having passed the first lens 8.

When the tilt is set at +10°, the beam inputted from the add port 13 is subjected to a change in the optical path with the micro-mirror 20 and is then outputted toward the input/output port 2 after returning to the principal optical path.

Accordingly, the switching of ports to input→output, input→drop, and add→output can be realized independently for each channel.

Here, the optical system element 7 for beam expanding in FIG. 7 and FIGS. 8A and 8B is the so-called Galilei type, combining the lens 5 having a positive focal length and lens 6 having a negative focal length. The element 7 may also comprise lenses with positive focal lengths.

FIG. 10 and FIG. 11 illustrate examples of the other optical systems similar to the system of FIG. 7. The wavelength selection control device may also employ the structure illustrated in these figures.

As illustrated in FIG. 10, at least one lens of the second and third lenses 5, 6 forming the optical system element 7 for beam expanding may also be formed of an achromat lens combining a glass lens having a positive low refractive index, for example, crown glass, and a glass meniscus lens having a negative high refractive index, for example, flint glass (the second lens 5a is the achromat lens in FIG. 10).

With the structure described above, color difference generated by the optical system element 7 and lens 8 can be compensated. Accordingly, this serves to compensate for deviation of the beam waist (focal point) position from the area of light returning component 11 due to differences in wavelengths generated by the spectral analysis.

When the light is returned to the spectral element 3 from the light returning component 12, the focusing position on the input/output ports 3, 13, 14 can be matched among the analyzed wavelengths (channels) and loss generated among the wavelengths (channels) can also be made identical by controlling the beam waist (focal point) positions to be matched on the reflection surface of the light returning component 12.

The structure providing the operation effect similar to that of FIG. 10 may also be structured as in FIG. 11, illustrating an embodiment in which the optical system element 7 for beam expanding is formed of at least three lenses.

The lens of short focal length added to optical system element 7 for beam expanding between the second and third lenses 5 and 6 may be constructed equivalently by combining at least two or more lenses having radii of curvature (=longer focal length) that are larger than those of the above lenses. (In FIG. 11, the third lens is indicated equivalently with two layers of lenses 6a, 6b.)

In FIG. 11, the optical system element 7 for beam expanding is formed of an equivalent lens system combining two or more lenses and an achromat lens.

3. Detailed Description of FIG. 11

In FIG. 11, the second lens (lens having the positive focal length) 5a forming the optical system element 7 for beam expanding is formed of the achromat lens combining a glass (crown glass) lens having a positive low refractive index and a glass (flint glass) meniscus lens having a negative high refractive index.

The focal length of this achromat lens is selected to be 62 mm which is identical to that of FIG. 7.

The lens having a short focal length (f=−6.56 mm) forming the optical system element 7 for beam expanding is formed of two sheets of lenses 6a, 6b having the longer focal length (f=15 mm).

The equivalent focal length f=−6.56 mm is realized with two layers of lenses 6a, 6b by setting the distance between the second principal point of the lens 6a of the first sheet and the first principal point of the lens 6b of the second sheet to 4.3 mm.

The optical system element 7 for beam expanding is constructed through the confocal arrangement of the combined focal point of these two lenses and the focal point of the second lens 5a.

FIGS. 12A and 12B illustrate the results of calculation of astigmatism of spot array 11 for the optical systems of FIGS. 7, 10, and 11.

FIG. 12A illustrates the beam waist position of the beam array 11 viewed from the X-Z plane, while FIG. 12B illustrates the beam waist position of the beam array 11 viewed from the Y-Z plane.

The horizontal axis indicates the positions in the optical axis (Z) direction, and zero (0) indicates the waist position of the beam at the center of the optical axis (1545 nm in this embodiment).

The vertical axis indicates the positions in the X direction, 0 (zero) indicates the center position of the optical axis, and E indicates the beam position corresponding to the extreme end wavelength (1525 nm or 1565 nm in this embodiment) of the wavelength multiplex signal light.

Since the X direction is the symmetry axis for the center of optical axis, only the single side is illustrated.

The circular beam in the optical system (C) of FIG. 7 can be obtained from this result, because the beam at the center of the optical axis becomes the beam waist when Z becomes equal to 0 for X and Y directions.

However, if the beam is of a wavelength at the extreme end of the spectrum, the beam waist positions vary in the X and Y directions. Therefore, the elliptical beam may be obtained. It can also be understood that the beam waist position in the optical axis (Z) direction is also deviated from the position of Z=0. That is, the beam array is not arranged on the line.

Meanwhile, the degree of eccentricity in the shape of beam becomes small (i.e. the amount of aberration is improved) when the structure of lens is changed as illustrated in FIG. 10(B) and FIG. 11(C). In this case, it can be confirmed that the beam array is arranged on the line.

Additionally, FIGS. 13A and 13B illustrate the other structures of the wavelength selection control device. In these figures, FIG. 13B is the cross-sectional view along the cutting line B-B′ of FIG. 13A.

A reflection type diffraction grating is used as the spectral element 3. The optical system element 7 for beam expansion is constructed such that f2>f3 for the focal lengths of the second and third lenses 5 and 6.

Here, the second and third lenses are formed of lenses having the radius of curvature at least in the X direction and the focal lengths of these lenses indicate the values in the Z direction.

The collimate beam 1 including the wavelength multiplex signal light is incident from the side of the third lens 6 of the optical system element 7 for beam expanding, expanded in the beam diameter in the X direction is magnified up to (f2/f3) times, and is then inputted to the reflection type diffraction grating 3.

The reflection type diffraction grating 3 spreads the wavelength multiplex signal light into a plurality of beams 4 (indicated as the solid line, broken line, and chain line in FIG. 13), in which each wavelength propagates in a different direction and then returns the beams to the optical system element 7 for beam expansion.

Here, an input light angle is set for the reflection type diffraction grating 3 to form the Littrow mounting in which the input light angle is set almost equal to the spread (diffraction) angle for the almost center wavelength of the wavelength band of the incident wavelength multiplex signal light 1.

Moreover, the beam 4 has an angle in the X direction illustrated.

The spread beam 4 is reduced in its beam diameter in the angular direction (X direction) by a factor of f3/f2 and is then expanded in the spread angle (angle formed for the optical axis) by a factor of f2/f3 after having passed again through the optical system element 7 for beam expanding.

The first lens 8 (of focal length f1) is positioned to convert the beam 9 of each wavelength into the parallel light beams 10.

These beams form the single dimensional (X direction) spot array 11, space-spread for each wavelength in the distance of f1 (focal length of the first lens) after having passed the first lens 8.

Moreover, it is also possible to introduce the structure that the space-spread beam spot of each wavelength can be returned to the spectral element 3 by the light returning component 12 as illustrated in FIGS. 13A and 13B.

In this case, the light returning component 12 is positioned to provide the reflection point at the position of beam spot (focal point) generated by the first lens 8.

Moreover, the light returning component 12 preferably includes the first reflection means for returning the beam in the direction accurately opposing the direction of propagation of the incident light, and the second reflection means for reflecting the beam in a direction that is different from that provided by the first reflecting means.

It is also preferable that the returning direction of the second reflection means be within the plane (Y-Z plane) vertical to the spread direction (X direction) of the spectral element.

In FIGS. 13A and 13B, the light of the wavelength indicated by the solid line is reflected by the first reflection means. Moreover, the lights of the wavelengths indicated by the broken line and chain line are reflected by the second reflection means. The first reflection means and second reflection means can be switched and the returning direction of beam of each wavelength can be switched by controlling the light returning component 12. The beam returned accurately in the opposing direction with the first reflection means is returned accurately to the incident (input) port 2.

The beam returned in a direction different from the incident direction by the second reflection means (indicated with a broken line in the cross-sectional view along the line B-B′ in FIGS. 13A and 13B) is returned to the other port 17.

In FIGS. 13A and 13B illustrating the wavelength selection control device of the present invention, the spectral element 3 is a reflection type diffraction grating that may consist of various materials, for example, a quartz glass substrate may be used.

The grating of the relevant reflection type diffraction grating is formed by the etching process over the substrate. The reflection film is formed thereon by vacuum evaporation or the like.

In the structures of FIGS. 13A and 13B, the optical system element 7 for beam expanding comprising the second and third lenses and the first lens 8 are configured in the structures identical to FIG. 7 (focal lengths are identical).

The optical fiber is formed into two ports and each port functions as the input/output port 2 and add/drop port 17.

As illustrated in FIGS. 13A and 13B, these optical fiber ports are arranged to input and output the beam 1 to the diffraction grating 3 from the third lens 6 of the optical system element 7 for beam expanding.

In this case, the beam is set to be inputted at the input light angle (=θ f) of 3° to the principal optical axis with the Y-Z plane defined as the incident plane.

The wavelength multiplex signal light 1 has the wavelength range, for example, of 1525 nm to 1565 nm (center wavelength: 1545 nm) and the channel interval of 0.8 nm.

Moreover, the collimate beam 1 inputted or outputted to or from the optical fiber port is the circular beam having the diameter of 0.36 mm both in the X and Y directions.

The input collimate beam 1 from the input/output port 2 is first inputted to the optical system element 7 for beam expanding from the side of third lens 6 for expanding the beam diameter in the X direction.

An expanding ratio is determined from the focal point ratio of the second and third lenses 5 and 6 forming the optical system element 7 for beam expanding. In this embodiment, the expanding ratio is about 9.5 (=62/6.56).

Accordingly, the collimate beam 4 is changed, after having passed the optical system element 7 for beam expanding, to the elliptical beam in the diameter in the X direction of 3.42 mm and the diameter in the Y direction of 0.36 mm. This elliptical beam is incident to the diffraction grating 3.

The diffraction grating 3 has 600 grooves/mm and the input light angle to the diffraction grating is set to 27.7° for the center wavelength to form the Littrow mounting.

In this case, the wavelength multiplex signal light is spread in the diffraction angle of center wavelength of 27.7° (identical to the input light angle) and spread angle width of 1.55° (diffraction angle of each wavelength is 26.75° for 1525 nm, 27.7° for 1545 nm, and 28.3° for 1565 nm).

Moreover, the tilt angle (θ×) of the diffraction grating is set to 1.50 so that the spread beam generated in the diffraction grating passes near the center of each of the first through third lenses.

The angled beam 4 passes through the optical system element 7 for beam expansion and is thereby expanded in the spread angle width. The expansion rate is determined with the focal point ratio of the second and third lenses 5, 6 forming the optical system element for beam expansion. In the case of this embodiment, the expansion ratio is about 9.5 (=62/6.56).

Therefore, after having passed the optical system element 7 for beam expansion, the spread beam 9 is propagated with a spread angle width increasing up to 14.7°.

Moreover, the spread beam 9 is converted into the circular beam having a diameter of 0.36 mm both in the X and Y direction through reduction of diameter only in the angular direction to 1/9.5 (inverse value of the expansion rate).

Thereafter, the spread beam is converted into the parallel beam 10 by the first lens 8 and each collimate beam 10 is reduced in diameter at the focal point position to form the beam spot 11 for each wavelength.

The spot diameter of each beam 11 is reduced by the first lens 8 (f=41.3 mm) to about 100 μm. Moreover, the beam interval of each channel becomes about 200 μm.

Accordingly, the single dimension (X direction) spot array 11 can be formed by space isolation of the wavelength multiplex signal light for each channel.

In addition, as in the case of FIGS. 8A and 8B, the movable micro-mirror 20 is arranged as an optical component (the pitch of the micro-mirror is about 200 μm). The movable micro-mirror 20 is arranged such that the reflection surface of the micro-mirror 20 is located at the position 11 of the beam spot (focal point) generated by the first lens 8.

Moreover, direction of the tilt angle of micro-mirror is set stably so that the beam is returned from the spectral element 3 in the direction accurately opposing the propagation direction of the incident light.

The movable micro-mirror 20 has two stable states (0°, +10°), and is arranged in the identical pitch to the interval (about 200 μm) of the beam spot array 11 and the beam returning direction can be controlled independently for each channel.

Here, the moving direction of the micro-mirror 20 and arrangement direction of the optical fibers 2, 17 (two ports) are set in the perpendicular direction (Y direction) to the angular direction (X direction).

When the tilt of the micro-mirror 20 is 0°, the beam 1 inputted from the input/output port 2 is returned to the input/output port 2.

When the tilt is +10°, the beam 1 inputted from the input/output port 2 is subjected to a conversion of optical path by the micro-mirror 20 and is then outputted to the add/drop port 17 traveling parallel to the principal optical path (the input optical path from the input/output port) after having passed through the first lens 8.

Additionally, the beam 21 inputted from the add/drop port 17 is subjected to a conversion of the optical path by the micro-mirror 20 and is then outputted from the input/output port 2 through the principal optical path.

Accordingly, the port switching of input output, input drop, add output can be realized independently for each channel.

It is also possible to use lenses with radii of curvature in both X and Y directions as the first and second lenses 15, 16 forming the optical system element 7 for beam expanding as illustrated in FIGS. 14A, 14B. In this embodiment, the optical system element 7 for beam expansion has the beam expanding and compressing functions both in the X and Y directions.

It is preferable that the collimate beams 1, 21 including the wavelength multiplex signal light be inputted from the Y-Z plane as the incident plane including the propagation optical axis of near the center wavelength beam spread through the Littrow mounting and be inputted into the optical system element 7 for beam expansion at the angle of θf=θg·f2/f3 for the propagation optical axis.

Moreover, it is desirable that the tilt angle (θx) of the spectral element be set in a manner such that the spread beam generated by the spectral element passes near the center of each of the first through third lenses.

4. Detailed Description of FIGS. 14A and 14B.

In FIGS. 14A and 14B, FIG. 14B is the cross-sectional view along the cutting line B-B′ in FIG. 14A.

The lenses 15, 16 having the radius of curvature both in the X and Y directions are used as the second and third lenses forming the optical system element 7 for beam expansion. The beam expansion and compression functions are also provided in the direction (Y direction) perpendicular to the angular direction (X direction).

In this embodiment, a convex lens with focal length f=62 mm is used as the second lens 15, while a concave lens with focal length f=−6.56 mm is used as the third lens 16. Thereby, the optical system element for beam expanding also has the magnification factor of about 9.5 (=62/6.56) in the Y direction.

When the input light angle to the diffraction grating 3 in the X-Z plane (θg) is set to 3° (tilt angle θ× of diffraction grating 3: 1.5°), the input/output angle of the optical fiber ports 2, 17 (angle formed by the input/output port and principal optical axis: Of) is expanded to 28.5° through magnification equal to the magnification factor provided by the optical system element 7 for beam expansion.

Namely, since the optical system element 7 for beam expansion is given the beam diameter expansion and compression function both in X and Y directions, the angle θf of the optical fiber ports 2, 17 can be expanded up to 28.5°(=3°×9.5) from 3° in FIGS. 13A and 13B.

5. Detailed comparison between the structural diagrams FIG. 7, FIGS. 8A and 8B, FIG. 10, FIG. 11, FIGS. 13A and 13B, and FIGS. 14A and 14B.

The total length L of the spread optical system of prior art 1 illustrated in FIG. 6 is expressed by the following formula.
L=2·ΔX/tan (Δθ)
ΔX: Space isolation distance of adjacent channels;
Δθ: Spread angle difference of adjacent channels;

The total length L of the spread optical system of prior art 2 illustrated in FIG. 5 is expressed by the following formula.
L=d+ΔX/tan (Δθ)
D: Distance up to the light returning component from the grating;
ΔX: Space isolation distance of adjacent channels;
Δθ: Spread angle difference of adjacent channels;

In comparison, the total length L of the spread optical system of the present invention (FIG. 7) is expressed by the following formula.
L=f2+f3+d+2·ΔX/tan (f2·Δθ/f3)
f2: Focal length of the second lens;
f3: Focal length of the third lens;
d: Distance between the second lens and spread element;
ΔX: Space isolation distance of adjacent channels;
Δθ: Spread angle difference of adjacent channels;
When it is assumed that Δθ=0.03°, f2=60 mm, f3=06 mm (magnification rate of expanding=10 times), and d=5 mm, the calculation results of FIG. 9 can be obtained for the length of the optical system.

For example, the lengthy distance of 180 cm is required in the spread optical system of the prior art 1 for space isolation of the wavelength multiplex signal light of the wavelength interval of 0.8 nm at a pitch of 0.5 mm, but only 25 cm is required in the optical system of the present invention, realizing a reduction in distance to nearly 1/7 that required by the prior art.

Moreover, even in comparison with the optical system (prior art 2) in which two diffraction gratings are combined for greater reduction in size (as illustrated in FIG. 5), the total length of the present invention realizes a reduction in size to nearly 1/4.

As described above, the spectral optical system (present invention) having combined the spectral element and optical system element 7 for beam expanding can provide a significant reduction in the length of the optical system.

Moreover, application of the optical system element for beam expanding that is formed of a set of lenses in varying focal lengths brings about the advantage that the spread angle can be expanded without the deterioration characteristic of insertion loss and dependence on polarization (PDL).

In addition, when the optical system element 7 for beam expanding is configured in the so-called Galilei type by combining a lens having a positive focal length and a lens having a negative focal length, the length of optical system can be further reduced.

Further, as illustrated in FIG. 10 and FIG. 11, the placing of a lens with shorter focal length among the second and third lenses comprising the optical system element 7 for beam expansion is equivalent to employing at least two or more lenses having a focal length longer than that of above lens (with a larger radius of curvature of lens). Consequently, aberration of spot array space-spread for each wavelength can be minimized, resulting in significant reduction in the insertion loss.

Similarly, it is possible to minimize aberrations of spot array space-isolated for each wavelength, as well as to reduce insertion loss, by choosing at least one of the second and third lenses comprising the optical system element 7 for beam expansion to be an achromat lens, formed by combining a glass lens having a positive low refraction index (e.g. crown glass), and the glass meniscus lens having a negative high refraction index (e.g. flint glass).

When the reflection type diffraction grating is selected as the spectral element and the wavelength multiplex signal light is reciprocally propagated through the optical system for beam expansion as illustrated in FIGS. 13A and 13B, the diffraction grating can be positioned in the Littrow mounting, in which the input light angle becomes equal to the refraction (spread) angle near the center wavelength of the wavelength band of the wavelength multiplex signal light.

In general, the high efficiency diffraction grating represented by the blazed type grating can reduce the insertion loss by obtaining high diffraction efficiency through the Littrow mounting.

In addition to these advantages, in the present invention, the optical system element 7 for beam expansion can expand the spread angle of the beam spread by the spectral element and reduce the beam diameter.

Here, the beam is generally more spread (expanded) in diameter and such a beam becomes undesirable for space propagation compared to smaller diameter beams as described by the Gaussian beam. Accordingly, the reduction in the beam diameter is naturally limited.

Therefore, in the optical system using the transmitting type spread element illustrated in FIG. 7, it is recommended to previously expand the beam diameter at the input/output port so that propagation of the beam is not lessened due to the reduction in the beam after passing through the optical system element 7 for beam expanding.

Particularly in the case of the beam expansion in only one direction (for example, the X direction), the beam at the input/output port must be converted to the elliptical shape. When the optical system is employed, in which the beam is reciprocally transmitted within the optical system element 7 for beam expanding as illustrated in FIGS. 13A and 13B, it is no longer required to previously expand the beam diameter and to deform the shape of beam to the elliptical shape.

In addition, if preceding expansion of the beam diameter is not required, the fiber array of the input/output port can be arranged to the narrower pitch in view of reduction in size of device.

Moreover, when the optical system element for beam expanding is designed to expand and compress the beam diameter in the vertical direction (Y direction), in addition to the spread direction (X direction) of the spectral element, the angle of the input/output port (angle formed for the optical axis) can be set to a large value in accordance with the magnification factor of the optical system element for beam expanding. (The angle θf formed by the input/output port and the optical axis can be expressed as θf=α·θg when the input light angle to the spectral element is θg for the magnification factor in beam expanding of a times.) Accordingly, the fiber array of the input/output port can be easily positioned to avoid the other lenses resulting in increased simplicity of manufacturing.

Particularly, setting of the optical axis of the input/output port in the Y-Z plane corresponds to the Littrow mounting of the reflection type diffraction grating (an arrangement in which the input light angle is identical to the diffraction angle). This setting can provide the simultaneous, advantages of a simplified manufacturing process and a reduction in insertion loss.

It is possible to further minimize coupling loss by positioning the reflection point of the light returning component at the focal points generated by the passage of the light beam through the lens that converts the divergent beams into parallel beams.

Moreover, when the beam incident to the light returning component is returned in a direction different from the incident direction, given that the reflection point remains positioned at the focal point of the beam spot as illustrated in FIGS. 8A and 8B, FIGS. 13A and 13B, and FIGS. 14A and 14B, the reflected beam is returned, after having passed the first lens, as a beam parallel to the incident direction wherein the optical axis is shifted. (Here, the amount of shift in the optical axis depends upon the reflection angle at the light returning component.)

Since this parallel orientation is maintained through the main transmission path, up to the input/output port, the output port of the beam, positioned according to the shift in path induced by the reflecting component, may be connected with a plurality of optical fibers arranged in parallel with the optical axes thereof.

Moreover, each beam that has been subjected to the change of optical path by the light returning component is arranged, at the input/output port, on a line in the particular direction. This is accomplished by limiting the returning direction of each individual light returning component corresponding to each angular dispersion beam to a certain plane. Therefore, a plurality of input/output ports can easily be realized with the single dimensional fiber array, enabling a reduction in the number of components and simplifying the manufacturing of the apparatus.

Furthermore, it is also possible to provide a structure corresponding to the Littrow mounting of the reflection type diffraction grating (an arrangement wherein the input light angle is identical to the diffraction angle) by limiting the returning direction of individual optical components corresponding to each angular dispersion beam to the plane (Y-Z plane) perpendicular to the spread direction of the spectral element. Therefore, the input/output port can be realized with a single dimensional fiber array resulting in the a reduction in insertion loss.

Accordingly, owing to the effects described above, it is possible for the wavelength selection control device to mitigate the imitations of the prior arts and to provide an optical system that enables reduction in size. Moreover, such an optical system is capable of significantly contributing to advances in desired characteristics, e.g. reduced insertion loss and PDL, as well as simplifying the manufacturing process.

Therefore, the present invention can realize the wavelength selection control device that enables a reduction in size and an increase in economy of design.

1. A wavelength selection device, comprising:
a spectral element for receiving the wavelength multiplexed signal and generating an angular dispersion beam having a spread angle width and a different angle for each wavelength within the beam;
optics for expanding the spread angle width of the angular dispersion beam; and
a first lens for generating a spot array, space isolated for each wavelength, by converting the angular dispersion beam into a set of parallel beams.

2. The wavelength selection device as described in claim 1, wherein the spectral element is a reflection type element, wherein the generated beam passes through the optics in reciprocal directions, and wherein a Littrow mounting causes the wavelength multiplexed signal to enter the spectral element at an angle substantially identical to the diffraction angle of the center wavelength of the angular dispersion beam.

3. The wavelength selection device as described in claim 1, wherein the optics allow for expansion or compression of the beam in the plane perpendicular both to the spread plane and the propagation direction of the generated beam, in addition to the spread direction of the spectral element.

4. The wavelength selection device as described in claim 1, further comprising a light returning component for reflecting the generated beam to the spectral element, having a reflection point positioned at the focal point of the first lens.

5. The wavelength selection device according to claim 4, wherein the light returning component comprises a reflection means for returning the generated beam in a direction opposed to the direction of propagation of the incident light in a first configuration, and for returning the generated beam in a different direction in a second configuration.

6. A wavelength selection device, comprising:
a spectral element capable of angular dispersion of incident light;
optics capable of expanding the spread angle width of an incident angular dispersion beam; and
a first lens capable of collimating an angular dispersion beam into a set of parallel beams.

7. The wavelength selection device according to claim 6, wherein the optics comprise a second lens and a third lens, each having different focal lengths, that are positioned in a confocal arrangement.

8. The wavelength selection device described in claim 7, wherein the second and third lenses comprise a combination of a lens having a positive focal length and a lens having a negative focal length.

9. The wavelength selection device described in claim 6, wherein at least one of the second and third lenses comprises an achromat lens, which combines a lens having a positive low refraction index with a meniscus lens having a negative high refraction index.

10. The wavelength selection device described in claim 6, wherein one of the second or third lenses is replaced with at least two lenses, together comprising an optical system having an effective radius of curvature that exceeds that of the replaced lens.

11. The wavelength selection device described in claim 6, wherein the spectral element is a diffraction grating.

12. The wavelength selection device described in claim 6, wherein the incident wavelength multiplexed beam and the diffraction grating are positioned in a Littrow mounting.

13. The wavelength selection device described in claim 7, wherein the lenses have curvature in more than one direction perpendicular to the propagation direction of the wavelength multiplexed signal.

14. The wavelength selection device described in claim 12, wherein the incident plane of the wavelength multiplex signal light for the optical system element is positioned within the Y-Z plane, including the optical axis of propagation of near center wavelength light spread by the Littrow mounting.

15. The wavelength selection device described in claim 6, further comprising a light returning component having a reflection point positioned at the focal point generated by the first lens.

16. The wavelength selection device described in claim 15, wherein the light returning component comprises a reflection means.

17. The wavelength selection device described in claim 16, wherein the returning direction of the reflection means lies in a plane perpendicular to the spread direction of the spectral element.

18. The wavelength selection device described in claim 15, wherein the reflection point of the light returning component is positioned at the movable portion of the micro-machine; and wherein the return direction of the reflected light beam can be adjusted by displacing the movable portion of the micro-machine.
